(19) United States
(12) Patent Application Publication
(10) Pub. No.: US 2024/0323012 A1
(43) Pub. Date: Sep. 26, 2024

(54) DEVICES AND METHODS FOR AUTHENTICATING PROPERTIES OF PHYSICAL OBJECTS

(71) Applicant: Capital One Services, LLC, McLean, VA (US)

(72) Inventors: Kevin Osborn, Newton Highlands, MA (US); Jeffrey Rule, Chevy Chase, MD (US)

(73) Assignee: Capital One Services, LLC, McLean, VA (US)

(21) Appl. No.: 18/124,642

(22) Filed: Mar. 22, 2023

(51) Int. Cl. H04L 9/08; H04L 9/30

(52) U.S. Cl. CPC H04L 9/088; H04L 9/30

(57) ABSTRACT

Systems, methods, apparatuses, and computer-readable media for management of physical object authentication are described. For example, a system may include a physical object and an authentication device coupled to the physical object. The authentication device may include an antenna, a processor, a secure enclave comprising a private key uniquely associated with the physical object via a public key stored in a blockchain; and memory comprising instructions that, when executed by the processor, cause the processor to receive signals comprising a challenge element via the antenna, identify the challenge element as corresponding to a verification request, sign the challenge element with the private key to produce a verification token for authentication of the physical object, transmit signals comprising the verification token via the antennae, wherein the verification token enables authentication of the physical object via the public key stored in the blockchain. Other embodiments are described.

### BACKGROUND

The value of a physical object may depend on certain properties that are not immediately apparent based on the outward characteristics of the object. For example, the market price of a collectible item may depend on the authenticity of the item, which may not be determined based on physical inspection alone. Conventional techniques for verifying the properties of an object (for instance, collectible footwear, a baseball card, a signed autograph, computer hardware, jewelry, etc.) may include the use of authenticity papers or certificates (for example, completed by an issuing company or a professional appraiser, grader, authenticator, and/or the like) or applying an identifier (for instance, a sticker, bar code, etc.) that indicates the authenticity or other properties. However, such devices are easy to forge, alter, or otherwise modify to falsely indicate the properties of the object. In addition, existing techniques do not allow verified status information, such as ownership status or transfer status, to be linked to an object in a manner that cannot be maliciously altered. As a result, a trustworthy process for determining the true value and/or status of an object is not available using conventional techniques.

### SUMMARY

Systems, methods, apparatuses, devices, and computer-readable media for managing physical object authentication are described.

In an example embodiment, a system may include a physical object; an authentication device integrally attached to the physical object, in which the authentication device may include: an antenna; a processor; a secure enclave comprising a private key uniquely associated with the physical object via a public key stored in a blockchain; and memory storing instructions. In various embodiments, the instructions, when executed by the processor, may cause the processor to: receive signals that include a challenge element via the antenna; identify the challenge element as corresponding to a verification request; sign the challenge element with the private key to produce a verification token for authentication of the physical object; and transmit signals that include the verification token via the antenna, wherein the verification token may enable authentication of the physical object via the public key stored in the blockchain.

In some embodiments of the system, the challenge element may include a random numeric item generated based on a randomization function, and the instructions, when executed by the processor, may cause the processor to provision the public key, the private key, and a unique identifier associated with the physical object.

In various embodiments of the system, the instructions, when executed by the processor, may further cause the processor to register the public key and a unique identifier associated with the physical object in the blockchain.

In some embodiments of the system, the instructions, when executed by the processor, may further cause the processor to register an owner of the physical object in the blockchain.

In exemplary embodiments of the system, the instructions, when executed by the processor, may further cause the processor to transfer ownership of the physical object from a first owner to a second owner in the blockchain.

In various embodiments of the system, the instructions, when executed by the processor, may further cause the processor to associate the first physical object with a second physical object in the blockchain to register a composite item comprised of the first physical object and the second physical object in the blockchain.

In some embodiments of the system, the second physical object of a composite item may be integrally attached to a second authentication device comprising a second antenna, a second processor, and a second secure enclave that includes a second private key uniquely associated with the second physical object via a second public key stored in the blockchain.

In various embodiments of the system, removal of the authentication device from the physical object may destroy functionality of at least one of the antenna, the processor, the secure enclave, and the memory.

In exemplary embodiments of the system, a portion of the physical object may be interwoven with the antenna to integrally attach the authentication device to the physical object.

In some embodiments of the system, the authentication device may include a digital cryptographic processor.

In an example embodiment, an apparatus may include an authentication device integrally attachable to a physical object, the authentication device may include: an antenna; a processor; a secure enclave comprising a private key uniquely associated with the physical object via a public key stored in a blockchain; and memory that may include instructions. In some embodiments, the instructions, when executed by the processor, may cause the processor to: receive signals comprising a challenge element via the antenna; identify the challenge element as corresponding to a verification request; sign the challenge element with the private key to produce a verification token for authentication of the physical object; and transmit signals comprising the verification token via the antenna, wherein the verification token may enable authentication of the physical object via the public key stored in the blockchain.

In some embodiments of the apparatus, the challenge element may include a random numeric item generated based on a randomization function, and the instructions, when executed by the processor, may cause the processor to provision the public key, the private key, and a unique identifier associated with the physical object.

In various embodiments of the apparatus, the instructions, when executed by the processor, may further cause the processor to register the public key and a unique identifier associated with the physical object in the blockchain.

In some embodiments of the apparatus, the instructions, when executed by the processor, may further cause the processor to register an owner of the physical object in the blockchain.

In various embodiments of the apparatus, the instructions, when executed by the processor, may further cause the processor to transfer ownership of the physical object from a first owner to a second owner in the blockchain.

In exemplary embodiments of the apparatus, the instructions, when executed by the processor, may further cause the processor to associate the first physical object with a second physical object in the blockchain to register a composite item comprised of the first physical object and the second physical object in the blockchain.

In some embodiments of the apparatus, the second physical object of a composite item may be integrally attached to a second authentication device comprising a second antenna, a second processor, and a second secure enclave that includes a second private key uniquely associated with the second physical object via a second public key stored in the blockchain.

In various embodiments of the apparatus, removal of the authentication device from the physical object may destroy functionality of at least one of the antenna, the processor, the secure enclave, and the memory.

In some embodiments of the apparatus, a portion of the physical object may be interwoven (or otherwise integrated) with the antenna to integrally (for instance, permanently or semi-permanently) attach the authentication device to the physical object.

In exemplary embodiments of the apparatus, the authentication device may include a digital cryptographic processor.

In an example embodiment, a method of authenticating a physical object may include, via an authentication device integrally attached to the physical object: receiving signals that include a challenge element via an antenna of the authentication device; identifying the challenge element as corresponding to a verification request; signing the challenge element with a private key stored in a secure enclave of the authentication device to produce a verification token for authentication of the physical object; and transmitting signals that include the verification token via the antenna, wherein the verification token may enable authentication of the physical object via a public key stored in a blockchain.

In some embodiments of the method, the method may include, via the authentication device, registering the public key and a unique identifier associated with the physical object in the blockchain.

One or more techniques described herein may enable increased adaptability, usability, and appeal of products, systems, and/or services offered via object authentication devices and/or methods, promoting improved products, systems, and/or services and leading to better functionality, increased convenience, and improved security. In these and other ways, components/techniques described here may identify methods to increase efficiency, decrease user input, improve usability, public perception, and/or expand desirability via realization of device-based object authentication in an accurate, reactive, efficient, dynamic, and scalable manner, resulting in several technical effects and advantages over conventional computer technology, including increased capabilities and improved adaptability. In various embodiments, one or more of the aspects, techniques, and/or components described herein may be implemented in a practical application via one or more computing devices, and thereby provide additional and useful functionality to the one or more computing devices, resulting in more capable, better functioning, and improved computing devices. Furthermore, one or more of the aspects, techniques, and/or components described herein may be utilized to improve one or more technical fields including object authentication, telecommunications, automated personal assistants, user interactions, and provision of products, systems, and/or services.

In several embodiments, components described herein may provide specific and particular manners to enable computer-based object authentication in a secure and tamper-proof manner. In several such embodiments, the specific and particular manners may include, for instance, receiving signals that include a challenge element via an antenna of an authentication device associated with a physical object, identifying the challenge element as corresponding to a verification request, signing the challenge element with a private key to produce a verification token for authentication of the physical object, and transmitting signals that include the verification token via the antenna, wherein the verification token may enable authentication of the physical object via the public key stored in a blockchain. In many embodiments, one or more of the components described herein may be implemented as a set of rules that improve computer-related technology by allowing a function not previously performable by a computer that enables an improved technological result to be achieved. For example, the function allowed may include one or more aspects of computer-based physical object authentication, automated personal assistants, user interactions, and provision of products, systems, and/or services described herein.

### BRIEF DESCRIPTION OF THE DRAWINGS

FIG. 1 illustrates an embodiment of a first operating environment according to the present disclosure.

FIG. 2 illustrates an embodiment of a cryptographic processor according to the present disclosure.

FIGS. 3A and 3B illustrate an embodiment of a second operating environment according to the present disclosure.

FIG. 4 illustrates an embodiment of an immutable distributed ledger for an authentication process according to the present disclosure.

FIG. 5 illustrates an embodiment of a blockchain according to the present disclosure.

FIG. 6 illustrates an embodiment of a first logic flow according to the present disclosure.

FIG. 7 illustrates an embodiment of a second logic flow according to the present disclosure.

FIG. 8 illustrates an embodiment of a computing architecture according to the present disclosure.

### DETAILED DESCRIPTION

For the purposes of promoting an understanding of the principles of the present disclosure, reference will now be made to the embodiments illustrated in the figures and specific language will be used to describe the same. It will nevertheless be understood that no limitation of the scope of the disclosure is thereby intended. Any alterations and further modifications in the described embodiments, and any further applications of the principles of the present disclosure as described herein are contemplated as would normally occur to one skilled in the art to which the disclosure relates.

The described technology generally relates to authenticating properties of physical objects using an authentication system. In some embodiments, an authentication system may include an authentication device and an object property storage system. The authentication device may include a logic circuitry, a computing device, and/or the like capable of performing an authentication process associated with a physical object. The authentication process may operate to securely and accurately authentic certain properties of an object attached to the authentication device.

In general, and without the intent to limit, a physical object may include any tangible article that the authentication device is capable of being associated with, for example, via attachment, mounting, affixation, embedding, integrating, and/or the like. In some embodiments, the authentication device may be associated with the article by being physically coupled to the article. In other embodiments, the authentication device may be associated with the article via other techniques (for instance, an identifier, image, and/or the like).

In various embodiments, the object property storage system may be or may include an immutable data storage system, for example, where data records may not be modified once stored in the object property storage system. In some embodiments, the immutable data storage system may be or may include a distributed ledger. In various embodiments, the distributed ledger may be or may include a blockchain system.

In various embodiments, the authentication process may include the use of encryption/decryption. In exemplary embodiments, the authentication device may be or may include a cryptographic processor configured to perform an encryption/decryption process as part of the authentication process. In some embodiments, the encryption/decryption process may use a public/private key pair to achieve key secrecy and to perform encryption/decryption functions.

In exemplary embodiments, an authentication device may include a cryptographic processor (CP) or digital CP (DCP) that employs a secure enclave for key secrecy into a physical object, product, article, and/or the like. Non-limiting examples of physical objects may be or may include footwear, clothing, paintings, automobiles, automobile parts, jewelry, electronic device, computing device, electronic devices and/or computing devices components, memorabilia, collectibles, containers, and/or the like. In some embodiments, the DCP may be permanently (or semi-permanently) affixed to a physical object. In various embodiments, the DCP may be configured to communicate with other devices (for instance, via wireless communication protocols), such as computing devices (for instance, a smartphone, personal computer, network device, and/or the like). In some embodiments, the DCP may be pre-provisioned with code, instructions, an application, and/or the like for performing encryption/decryption and other authentication processes, including, in one non-limiting example, digitally signing challenges (for example, a random number challenge).

In various embodiments, an authentication process may include provisioning a public/private key pair. In some embodiments, the public/private key pair may be generated by the DCP. In exemplary embodiments, the public/private key pair may be generated by a system external to the DCP and may be loaded onto the DCP, for example, during an initialization or registration process. In some embodiments, a unique object identifier (ID) may be generated for the object associated with the authentication device. In various embodiments, various security elements, such as the object ID and/or the private key may be stored in a memory of the authentication device, such as in the secure enclave. In various embodiments, the public key and the unique ID may be stored or may also be stored in the object property storage system, such as in an authentication system blockchain. For example, during an object registration process for registering the object with the authentication system, the public key and the unique ID may be exported (for instance, via the authentication device) along with an object state and stored in the blockchain. Non-limiting examples, of object states may be or may include a created state, a sold state, a transferred state, a verified state, a verified by state, a destroyed state, a merged state (for instance, merging the object with another object to create a composite object), and/or the like. Additional data, such as metadata, may also be associated with the physical object, the authentication device, a transaction, and/or the like.

In various embodiments, any transaction involving the physical object may be recorded in the object property storage system. For example, when the physical object changes ownership, this transaction may be recorded in the blockchain.

In some embodiments, the identity of the physical object may be verified via a status check process performed via the authentication device (for instance, in combination with a computing device, such as a smartphone, personal computer, and/or the like). In various embodiments, for example, a status check process may operate to return a secure, verified status of the physical object as stored in the blockchain. For instance, a random numeric item may be sent to the authentication device affixed to the physical subject. The random numeric item may be signed by the private key and may be verified via the public key for the physical object stored in the blockchain (for example, using chain of trust or other blockchain integrity processes to verify the trust and provenance of the public key). The results of the status check process may be recorded, for instance, as a transaction, on the blockchain.

In exemplary embodiments, the authentication device may have tamper-proof elements or functionality. For example, the authentication device may include an attachment indicator configured to determine if the authentication device has been removed from the physical object. Detection of removal of the authentication device may trigger one or more removal (or destruction) events, such as storing a removal transaction in the blockchain (or other storage system), terminating authentication device functions, and/or the like.

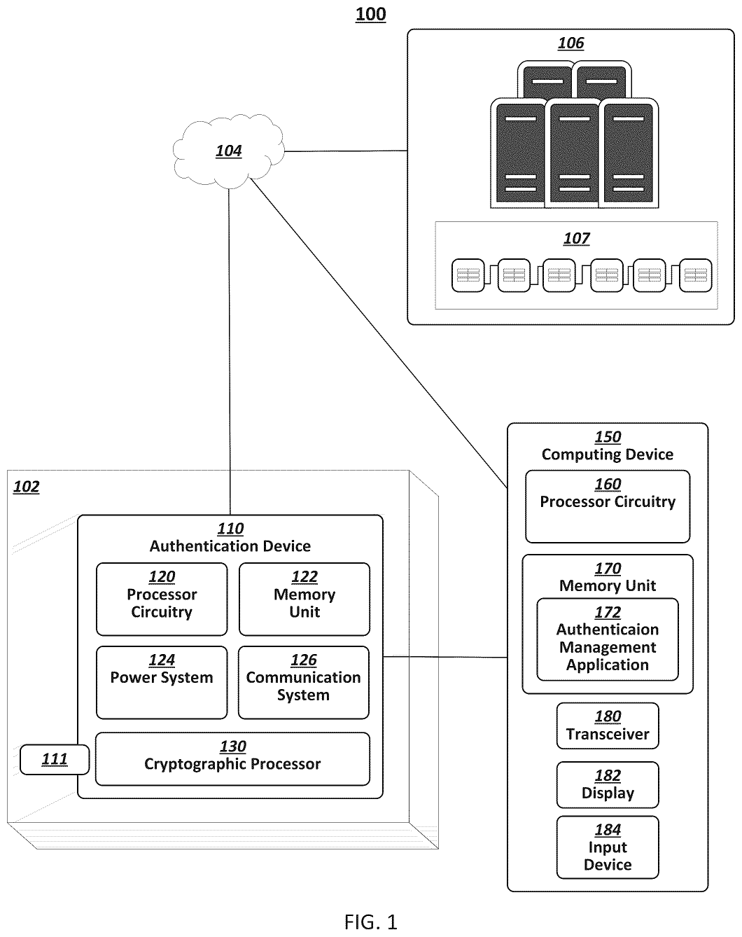

FIG. 1 illustrates an embodiment of a first operating environment according to the present disclosure. As shown in FIG. 1, an operating environment 100 may include an authentication device 110 coupled to a physical object 102. Authentication device 110 may be or may include circuitry, a logic device, a computing device, a system-on-a-chip, a computing or electronic module, a digital signal processor (DSP), and/or the like having a processor circuitry 120, a memory unit 122, a power system 124, a communication system 126, and/or a cryptographic processor 130.

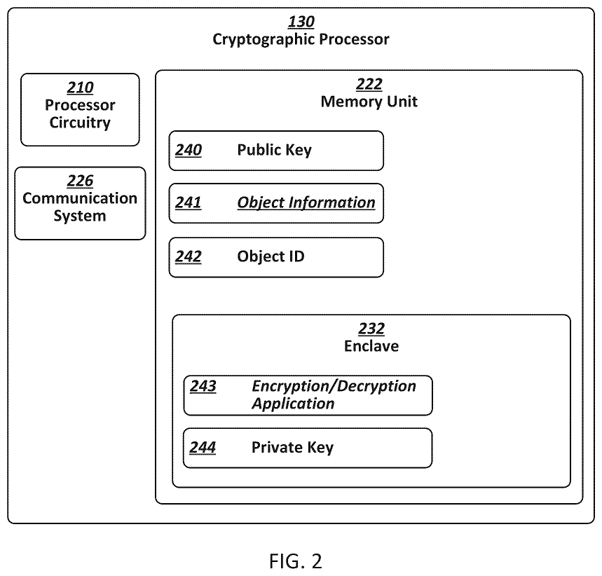

In various embodiments, authentication device 110 may not include processor circuitry 120, memory unit 122, and/or communication system 126 (or components thereof); instead, cryptographic processor 130 (or one or more components thereof) may operate to perform functions associated with processor circuitry 120, memory unit 122, and/or communication system 126 (see, for example, FIG. 2).

Physical object 102 may include any type of tangible article that may have an authentication device attached thereto. Non-limiting types of physical objects 102 may be or may include footwear, clothing, paintings, sculptures, automobiles, automobile parts, buildings or portions of buildings, furniture, jewelry, electronic devices, computing devices, smartphone, tablet computing device, personal computer, electronic device and/or computing device components, memorabilia, collectibles, containers, and/or the like. Embodiments are not limited in this context.

Authentication device 110 may be permanently (or semi-permanently) coupled to physical object 102. Authentication device 110 may be coupled to physical object 102 using various techniques, elements, and/or the like. Non-limiting techniques, elements, and/or the like for coupling authentication device 110 to physical object 102 may include adhesives, wires, ties, fasteners (for example, screws, rivets, snaps, staples, and/or the like), thread (i.e., via sewing), embedding (for example, authentication device 110 and/or components thereof may be directly embedded within the materials forming physical object 102), printing (for instance, printing circuitry onto a substrate forming physical object 102), and/or the like. Embodiments are not limited in this context.

In various embodiments, authentication device 110 may be associated with a tamper-proof indicator 111 configured to indicate when an individual has tampered with or attempted to tamper with authentication device 110 and/or the attachment of authentication device 110 to physical object 102. In various embodiments, tamper-proof indicator 111 may be arranged, at least partially, within authentication device 110. In exemplary embodiments, tamper-proof indicator 111 may be coupled to at least a portion of authentication device 110 and/or physical object 102. In some embodiments, tamper-proof indicator 111 may be a component of an element that couples authentication device to physical object 102.

In some embodiments, tamper-proof indicator 111 may include an element that may be broken, deformed, or otherwise modified when an individual attempts to tamper with the authentication device 110 and/or remove authentication device 110 from physical object. In various embodiments, tamper-proof indicator 111 may include circuitry, logic, and/or an electronic component that may be triggered to generate (or cause to be generated) a manipulation event signal by authentication device 110, authentication management system 106, and/or computing device 150 indicating that authentication device 110 has been manipulated (for instance, unauthorized access, tampering, removal, and/or the like).

For example, authentication device 110 (and/or a connection between authentication device 110 and physical object 102) may be configured such that authentication device 110 cannot be removed from physical object 102 without triggering a manipulation event (for instance, a removal event in particular). In another example, authentication device 110 may be configured such that each time a user accesses the authentication device 110 (for instance, via computing device 150) a manipulation event may be triggered (including for authorized and unauthorized access). In various embodiments, manipulation events may be recorded for the device, such as in a data storage system 107.

In some embodiments, communication system 126 may include an antenna (or other wire or other type of structure) engaged with a portion of the physical object 102 that operates as a tamper-proof indicator 111. For example, authentication device 110 cannot be removed from physical object 102 without breaking the antenna. Breakage of the antenna may be detected by authentication device 110 trigger a manipulation event (for instance, categorized as a removal or destruction event). In various embodiments, a manipulation event may trigger one or more tamper-proof functions, such as terminating authentication device 110 functions, access, and/or the like.

Processor circuitry, such as processor circuitry 120, may include and/or may access various logic for performing processes according to some embodiments. As used in this application, the terms “logic, “component,” “layer,” “system,” “circuitry,” “decoder,” “encoder,” and/or “module” are intended to refer to a computer-related entity, either hardware, a combination of hardware and software, software, or software in execution, examples of which are provided by the exemplary computing architecture 800. For example, a logic and/or circuitry may be and/or may include, but are not limited to, a processor, a central processing unit (CPU), a graphics processing unit (GPU), a process running on a processor, a processor, a hard disk drive, multiple storage drives (of optical and/or magnetic storage medium), an object, an executable, a thread of execution, a program, a computer, hardware circuitry, integrated circuits, application specific integrated circuits (ASIC), programmable logic devices (PLD), digital signal processors (DSP), field programmable gate array (FPGA), a system-on-a-chip (SoC), a microcontroller unit (MCU), a very large scale integration (VLSI) unit, memory units, logic gates, registers, semiconductor device, chips, microchips, chip sets, software components, programs, applications, firmware, software modules, computer code, combinations of any of the foregoing, and/or the like.

In various embodiments, processor circuitry 120 may include additional components, including processors, memories, error and parity/CRC checkers, data encoders, anticollision algorithms, controllers, command decoders, security primitives and tamper-proofing hardware and/or software, as necessary to perform the functions described in the present disclosure.

Memory unit 170 may include various types of computer-readable storage media and/or systems in the form of one or more higher speed memory units including, for example and without limitation such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory.

Power system 124 may include various elements and/or systems for providing power to authentication device 110, including battery power systems, rechargeable power systems, energy-harvesting power systems, and/or the like.

Communication system 126 may include various elements and/or systems for facilitating communication between authentication device 110 and external systems/devices, such as a network 104, a computing device 150, and/or the like. Communication system 126 may be or may include one or more antennae, transceivers, circuitry, and/or the like for facilitating wireless communication. Non-limiting examples of communication protocols implemented via communication system 126 may include near-field communication (NFC), the IEEE 802 family of standards, such as wireless devices operatively disposed in wireless communication (e.g., IEEE 802.16 over-the-air modulation techniques), which may include at least Wi-Fi (or Wireless Fidelity), WiMax, and Bluetooth™ wireless technologies, among others.

In some embodiments, operating environment 100 may include an authentication management system 106 configured to store authentication information and/or manage various functions of an authentication process according to various embodiments. In various embodiments, authentication management system 106 may include one or more computing devices, such as one or more servers. In exemplary embodiments, a server of authentication management system 106 may include one or more processors, which are coupled to a memory. The server may be configured as a central system, server, or platform to control and call various data and/or functions at different times to execute a plurality of workflow functions according to some embodiments.

The server may store, connect to, and/or manage one or more databases or storage systems, such as data storage system 107. In some embodiments, data storage system 107 may be configured to store authentication information. Authentication may include information associated directly with properties of physical object 102, such as a name, type of object, dimensions, manufacturer information, creation information (e.g., creation/manufacturing date), owner information, and/or the like. Authentication information may be or may include information of transactions associated with physical object 102, such as registration information (for instance, when physical object 102 was registered with authentication management system 106), sales, transfers, verifications (e.g., when a user checks the authenticity of physical object 102), removals (or destructions), manipulation events, mergers, and/or the like.

In various embodiments, data storage system 107 may be or may include an immutable storage system, for example, configured to allow addition of new records and to prevent modification of existing records. For example, new records (for instance, of a transaction) may be added, but previous records (for instance, of previous transactions) may not be modified. In some embodiments, data storage system 107 may be or may include an immutable distributed ledger. In various embodiments, data storage system 107 may be or may include a blockchain.

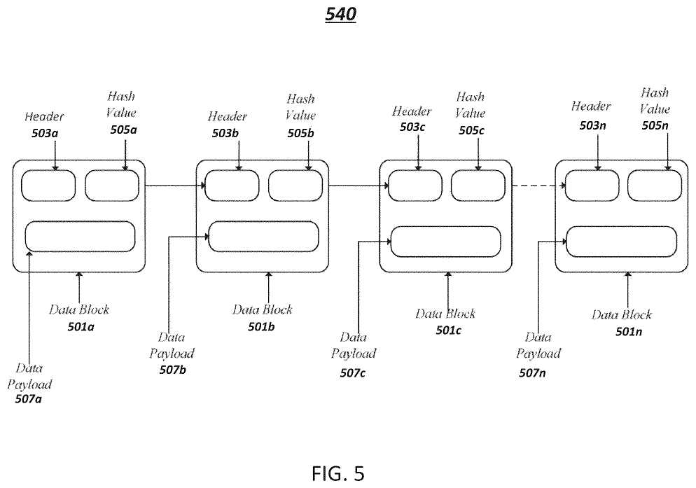

In general, a distributed ledger is a record of consensus with a cryptographic audit trail which is maintained and validated by a plurality of computing nodes. For example, a distributed ledger may be implemented as a database that is shared, replicated, and synchronized among the computing nodes of a decentralized network. The distributed ledger records transactions, such as data, asset exchanges, and/or the like. Distributed ledgers can be decentralized, granting equal rights within the protocol to all participants or centralized, designating certain users' particular rights. The state of a distributed ledger may be determined through a consensus algorithm operative to validate information from inputs to the network. A blockchain is a particular implementation of a distributed ledger that includes a shared, replicated ledger that is formed of unchangeable data in packages called blocks (see, for example, FIG. 5). A blockchain sits below a distributed ledger and acts as a way to order and validate the transactions in the ledger. Non-limiting examples of distributed ledgers (or blockchain implementations thereof) may include Ethereum, Hyperledger, Ripple, Quorum, Corda, combinations thereof, variations thereof, and/or the like.

Various implementations of a distributed ledger may include characteristics including, without limitation, a ledger, consensus, cryptography, provenance, and immutability. The ledger may include a shared, permissioned ledger which may operate as an append-only system of record in which new records may only be appended to the ledger and existing records cannot be deleted or modified. All participants within a network may have their own identical copy of the ledger and any changes to the ledger are reflected in all copies. Consensus is required to add information to the ledger. For example, in order for a new record or block to be created or a transaction to be written to an existing block, the record must be validated by a consensus algorithm. In general, a consensus protocol agreed to by participating members ensures that the ledger is updated only with network-verified transactions and, as a result, that all participants (or a threshold number of participants) agree on the network's validity. Non-limiting examples of consensus algorithms may include proof-of-work, Byzantine fault-tolerant replication, proof-of-stake, multi-signature, and/or the like.

Distributed ledgers use cryptography to maintain a peer-to-peer distributed, time-stamped, and immutable consensus ledger of all past transactions. Each transaction (or record of a transaction) is similar to a ledger line item, which is then aggregated with others into a block of records or transactions, essentially forming a chain of records (or blocks for a blockchain implementation), with each record connected to the previous record. For example, a distributed ledger involves a chain of cryptographic hashes in which each record contains a cryptographic hash to the previous record. The cryptographic hash may provide assurance as to the integrity of a record, for instance as a checksum, because any change to the contents of the record will result in a completely different cryptographic hash being produced. With each record referring back to the previous record, it is not possible to insert a new block or alter an existing record's contents, thus providing a range of guarantees as to the integrity of the order and contents of the records.

The provenance of a distributed ledger may generally refer to sources/processes that produce information/data. In cryptography, provenance may provide the linkage and other information to determine a source of information and/or a record. As such, distributed ledger technology can be used to determine the provenance of an asset or information, which may determine a source and/or a history of ownership of the asset or information. In addition, distributed ledgers may demonstrate immutability because network participants cannot tamper with transactions once they are recorded in the distributed ledger. For example, if a record or transaction is the result of an error, another record or transaction must be added to correct the error and both transactions (the original, erroneous record, and the corrected record) must be left visible to the network participants.

Distributed ledger technology may be used to implement smart contracts, which may include programmable contracts capable of automatically enforcing themselves when pre-defined conditions have been met.

One or more users, devices, and/or the like may have access to read and/or write to the distributed ledger. Such entities may access the distributed ledger via a secured or authenticated connection, with details of the entity accessing or modifying the distributed ledger being stored in the one or more transactions or blocks.

In various embodiments, authentication device 110 may be configured to be communicatively coupled to computing device 150 via one or more wired or wireless communication protocols. For example, authentication device 110 may be communicatively coupled to computing device 150 via network 104. In another example, authentication device 110 may be directly communicatively coupled to computing device 150 via one or more wireless communication protocols, such as NFC, Bluetooth, and/or the like.

In some embodiments, computing device 150 may operate as a client device which may be a network-enabled computing device. As referred to herein, a network-enabled computer may include, but is not limited to, a computer device, or communications device including, for example, a server, a network appliance, a personal computer, a workstation, a phone, a personal computer, a workstation, a personal digital assistant, a thin client, a fat client, an Internet browser, a point-of-sale device, combinations thereof, and/or the like. Computing device 150 may also be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, wearable mobile device (for instance, a smart watch), and/or the like.

Computing device 150 may include a processor circuitry 160, a memory unit 170, a transceiver 180, a display 182, and/or input devices 184 (for instance, a device for entering information into computing device 150, such as a touchscreen, keyboard, mouse, cursor-control device, touchscreen, microphone, digital camera, video recorder, and/or the like). In various embodiments, computing device 150 may execute one or more authentication management applications 172, such as a software application, mobile application (“mobile app” or “app”) that perform authentication management functions according to some embodiments.

For example, authentication management applications 172 may allow a user to connect to authentication device 110 and to perform various authentication management functions according to various embodiments, including, without limitation, viewing authentication information and/or physical object information, perform transactions (for instance, create, register, sell, transfer, merge, and/or the like), and/or the like.

In some embodiments, physical objects 102, each with an attached authentication device 110, may be merged to be treated by the authentication platform as a single (composite) physical object. For example, a first physical object and a second physical object may be registered in the blockchain as a composite item. The composite item may be treated as a single item for authentication purposes. For instance, verification of the composite item may require authentication of the first physical object and/or the second physical object (and/or a third object that is registered as representing the new composite item). In addition, or in the alternative, a transaction with a composite item may require verification that the objects that form the composite item are together, attached, installed, and/or otherwise merged. For example, authentication devices 110 of objects of a composite object may communicate with each other via wired and/or wireless communication protocols to verify that they are still merged in a composite item.

As shown in FIG. 1, authentication device 110 may be or may include a cryptographic processor 130. In some embodiments, cryptographic processor 130 may be an integrated circuit configured to provide a tamper-proof root of trust and secure storage (for instance, of cryptographic keys and/or authentication information) for authentication device 110. In various embodiments, cryptographic processor 130 may operate to perform cryptographic processing, alone, or in combination with other hardware/software elements of authentication device 110, such as processing circuitry 160, memory unit 170, and/or the like.

Cryptographic processor 130 may include a secure crypto-processor chip or a microprocessor dedicated to carrying out cryptographic operations, that may, in some embodiments, be embedded in a packaging with multiple physical security measures. Such measures may give cryptographic processor 130 a degree of tamper resistance. In some embodiments, cryptographic processor 130 may be configured to host or execute various applications and output encrypted or decrypted data.

In some embodiments, cryptographic processor 130 may be configured for public/private key encryption and/or decryption operations targeting network infrastructure across the enterprise and the data center. These operations may execute public key algorithms including, without limitation, RSA, Triple DES (3DES), Diffie Hellman and Elliptic Curve Cryptography (ECC), forming the basis of digital signature and key exchange protocols to make secure transactions possible.

FIG. 2 illustrates an embodiment of cryptographic processor 130 according to the present disclosure. As shown in FIG. 2, cryptographic processor 130 may include a processor circuitry 210, a communication system 226, and/or a memory unit 222. However, in some embodiments, cryptographic processor 130 may use processor circuitry 160, communication system 126, and/or memory unit 122 alone or in combination with processor circuitry 210, communication system 226, and/or memory unit 222 to perform functions according to various embodiments. In some embodiments, communication system 226 may be or may include one or more antennae, transceivers, and/or the like for performing wireless communication. In exemplary embodiments, processing circuitry 210 may be or may include an IC, MCU, CPU, GPU, logic circuit, and/or the like.

In various embodiments, cryptographic processor 130 may include an enclave 232. In general, enclave 232 may be a secure memory or portion of memory that is only used for encryption and/or decryption processes performed by cryptographic processor 130. Enclave 232 may be or may include a set of secure memory locations for an encryption/decryption application 243 and execution thereof, for instance, via execution of instructions by processor circuitry 210. Enclave 232 may be inaccessible to unauthorized processes.

Certain information may be stored in enclave 232. In some embodiments, a private key 244 for an encryption/decryption process performed via cryptographic processor 130 may be stored in enclave 232.

Cryptographic processor 130 may store other information, including, without limitation, a public key 240, an object identifier (ID) 241, and object information 242. In some embodiments, object ID 241 may include a unique ID generated for physical object 102 (for example, when created or registered within authentication management system 106). In various embodiments, object information 242 may include certain information associated with physical object 102, such as manufacturer/creator information, manufacturing/creation date, materials, version, components, type, style, owner(s), price information, value (or appraisal) information, and/or the like. In some embodiments, information, such as public key 240, object identifier (ID) 241, and/or object information 242, may be stored in enclave 232.

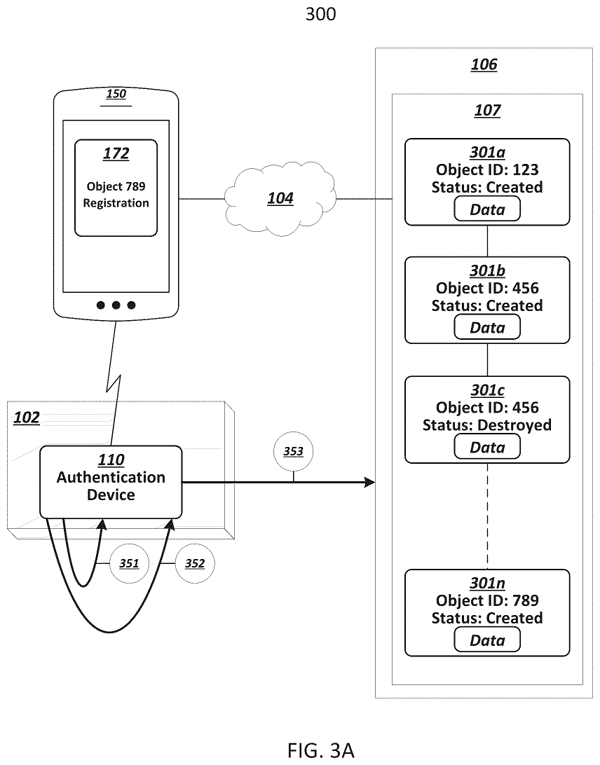

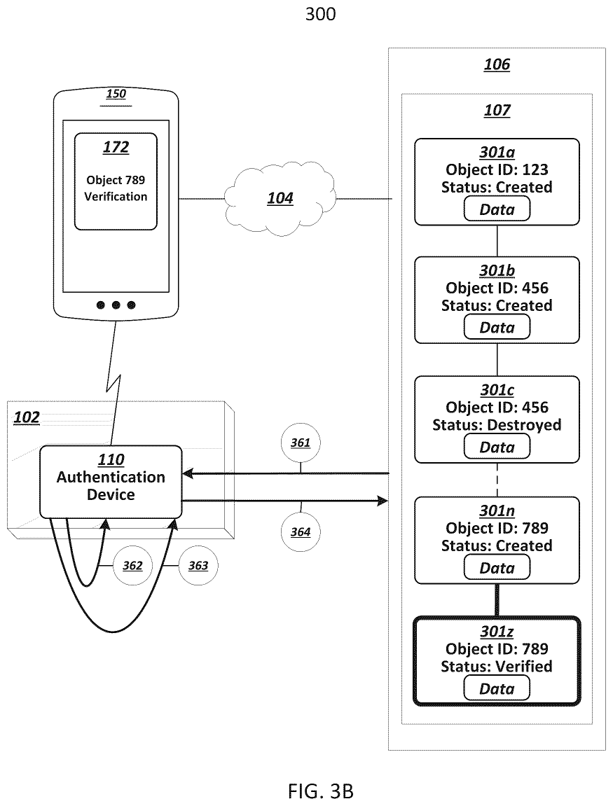

FIGS. 3A and 3B illustrate embodiments of a second operating environment according to the present disclosure. For example, FIG. 3A may generally depict object creation or registration according and FIG. 3B may generally depict a transaction according to some embodiments.

As shown in FIG. 3A, an operating environment 300 may include authentication device 110 coupled to physical object 102. Authentication management system 106 may include data storage system 107 configured as a blockchain. Authentication device 110 may be communicatively coupled to authentication management system 106. For example, authentication device 110 may directly communicate with authentication management system 106 through communication system 126 and/or communication system 226. In addition, or in the alternative, authentication device 110 may directly communicate with computing device 150, which may be communicatively coupled to authentication management system 106.

For instance, a user may bring computing device 150 sufficiently close to authentication device 110 for computing device 150 to detect authentication device 110, for example, via NFC, Bluetooth, and/or the like protocols. Authentication application 172 may be executed on computing device 150 to provide a graphical user interface and/or other software features that allow a user to access authentication processes or information and/or object information, for instance, stored in information storage system 107. For example, authentication application 172 may operate on computing device 150 to facilitate a user registering physical object 102 with authentication management system 106.

In some examples, physical object 102 may be manufactured or created with an authentication device 110. For instance, a smartphone may be manufactured with an embedded authentication device 110. In other examples, authentication device 110 may be affixed to a pre-existing physical object 102. For instance, an owner may want to use an authentication device 110 to allow others to verify collectible footwear manufactured and purchased over one-year prior. In this instance, the owner may purchase authentication device 110 and affix it to, or otherwise associate, it with the pre-existing collectible footwear.

In some embodiments, authentication device 110, for instance, via cryptographic processor 130, may determine 351 a public/private key pair for encryption/decryption processes. In various embodiments, the public/private key pair may be downloaded to authentication device 110 by a manufacturer of authentication device 110. In some embodiments, authentication device 110 may generate the public/private key pair, for instance, at a time of manufacture or responsive to a signal (for instance, initiation of a registration process). In certain embodiments, the public/private key pair may be generated by the authentication management system 106 and provided to the authentication device 110.

In exemplary embodiments, authentication device 110 may determine 352 a unique ID (for instance, object ID 242) for physical object 102. The unique ID may operate as an identifier of physical object within the authentication platform implemented via authentication management system 106. In various embodiments, the unique ID may be generated 352 by authentication device 110 at a time of manufacture or responsive to a prompt (for instance, from authentication application 172 and/or authentication management system 106). In the example of FIG. 3A, the unique ID is “789.”

In some embodiments, authentication device 110 may store the private key of the public/private key pair in enclave 232 of cryptographic processor 130. Authentication device 110 may export 353 the public key and the unique ID, for instance, for storage with authentication management application 106. The export process of the public key and the unique ID may be facilitated via authentication application 172 executing on computing device 150.

In some embodiments, blockchain 107 may include a plurality of blocks 301a-301c. Each block 301a-c may be associated with a physical object and/or a transaction associated with a physical object managed by the authentication platform implemented via authentication management system 106. As shown in FIG. 3A, responsive to registration of physical object 102 with the authentication platform, block 301n has been created in blockchain 107 indicated that an object with an object ID of “789” has been created. The object ID may also be stored on the authentication device 110 so that physical object 102 may be correlated with the authentication platform and/or records stored in blockchain 107. In some embodiments, the object ID may be stored in enclave 232 of cryptographic processor 230.

Referring to FIG. 3B, an authentication process may be performed via components of operating environment 300 to verify physical object 102 and/or to secure a transaction. For example, a user may seek to verify that a physical object 102 is authentic (for instance, a purchaser may desire to verify that an object corresponds with a seller's description prior to a purchase) via a verification transaction.

As shown in FIG. 3B, an authentication process may include a challenge encryption/decryption process 361. For example, a challenge element, such as a random number, may be received by authentication device 110 (for instance, received via an antenna of authentication device 110 from authentication management system 106 and/or computing device 150). The challenge element may be or may include various items, including a number, a string of characters, a code, a random number or string of characters. The random number or string of characters may be generated based on a randomization function. Authentication device 110 may then identify or verify 362 the challenge element as corresponding to a transaction, such as a verification request. In some embodiments, authentication device 110 may encrypt or sign the numeric item with the private key, stored in enclave 232, to produce a verification token 363. Verification token 363 may be transmitted at 364 to authentication management system 106 for authentication via the public key stored in blockchain 107. As shown in FIG. 3B, block 301z may be generated storing a transaction that physical object 102 has been verified.

In some embodiments, the type of transaction may be specified by a user, such as a sale, transfer, verification, and/or the like, which may be stored in blockchain 107. A user may be required to provide credentials in order to interact with authentication device 110, for instance, via application 172. For instance, a user may access application 172 and enter a username and password, biometric information, and/or the like in order to access the functions of application 172 (and the functions of authentication device 110). After verification of physical object 102 (for instance, as depicted in FIG. 3B), a user may specify a transaction and enter the information via application 172. For example, a user may select a “transfer object” function from a GUI of application 172, then enter the transfer information, such as the transferee, price, and/or the like. This information may be recorded in blockchain 107 to indicate that a transfer (or sale) transaction has occurred for physical object 102 and there is a new owner of physical object 102. In some embodiments, the new owner of physical object 102 may be required to register or re-register physical object with the authentication platform according to some embodiments.

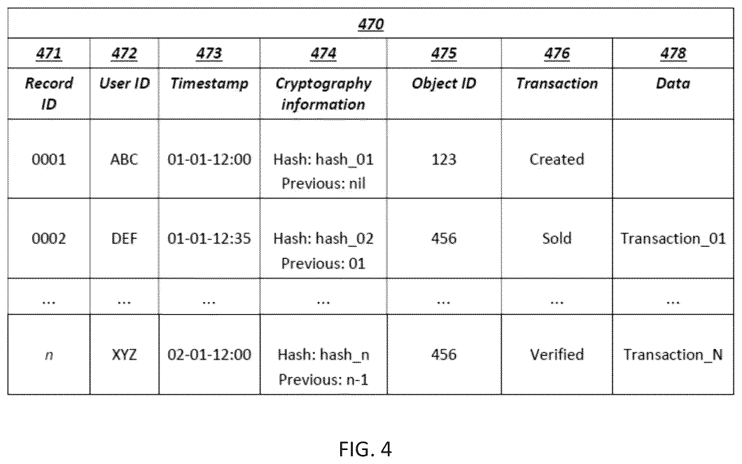

FIG. 4 illustrates an embodiment of an immutable distributed ledger for an authentication process according to the present disclosure. As shown in FIG. 4, distributed ledger 470 may include a database of records having various fields, such as a record ID 471 to uniquely identify the record, a user ID 472 to associate the user or entity associated with causing the record to be generated, and a timestamp 473 indicating when the record was created.

Each record may include cryptography information 474, for example, a unique hash and/or a pointer to the previous record. In this manner, if a record is changed or deleted, the cryptography information will not match, and it may be determined that the distributed ledger 470 has been changed. In some embodiments, each record may include an object ID 475 associated with the unique ID of the physical object associated with the record. In various embodiments, blockchain 470 may store transactions 476 associated with a physical object. In some embodiments, each record may be associated with data 478, such as a data payload, metadata associated with a physical object, user, transaction and/or the like.

FIG. 5 illustrates an embodiment of a blockchain according to the present disclosure. As shown in FIG. 5, a blockchain 540 consists essentially of a series of data blocks 501a 501n linked together in a manner described below. Data blocks 501 may include a header 503, a data payload 507, and the hash value 505. The hash value 505n of each data block 501n is included in the header 503n+1 of the next data block 501n+1 in the blockchain 540, thereby creating the chain.

Authentication management system 110 may be configured to store data payloads 507 in data blocks 501 in blockchain 540, consistent with disclosed embodiments. In some embodiments, authentication management system 106 may be configured to create new data blocks 501 for addition to blockchain 540, the data blocks 501 containing a data payload 507, the data payload 507 comprising one or more records (see, for example, FIG. 4). In various aspects, member systems may be configured to accept records for storage in blockchain 540 from computing device 150, authentication management system 106, and/or other computing nodes.

Blockchain 540 may be configured to store data payloads 507 from computing devices, the data payloads 507 including one or more records. Blockchain 540 may be distributed and comprise many copies of blockchain 540 maintained by different systems or nodes, for example, authentication management system 106 may have a local copy of the most recent version of blockchain 540. Such exemplary blockchains may comprise blocks, such as data blocks 501a . . . 501n. A data block 501n may include data payloads, such as data payload 507n, each data payload containing one or more records. Generally, data blocks 501 include a header, such as headers 503a . . . 503n, which uniquely identifies each block. The headers 503 may include a hash value generated by a hash function. For example, a header 503n may include at least the hash value of the previous block 503n-1 and may also include one or more of a hash value generated based on any data payload 507 in the data block 501, (e.g., a Merkle root), and a timestamp.

In order to be added to blockchain 540 each data block 501, must be completed by calculating a hash value 505 for that data block 501. In some embodiments, a hash value 505 may be a simple hash of the data block 501. In other embodiments hash value 505 may be the result of the satisfaction of a proof-of-work condition. Headers 503 may include a nonce chosen to ensure that the hash value 505 satisfies a proof-of-work condition. As a non-limiting example, the proof-of-work condition may require that a nonce be chosen for inclusion in data block 501 which causes the hash value 505 for data block 501 to fall within a predetermined range of values.

Additionally, header 503 may be digitally signed with a cryptographic key, and the digital signature may be included in the header 503. This digital signature may be verified using an available key. Blockchain 540 may comprise one or a combination of several different types of blockchain. In one embodiment, blockchain 540 may comprise, for example, a consortium blockchain in which all participants in the blockchain 540 are member systems, and wherein a proof-of-stake function determines which member system will complete each data block 501, that is, which member system will calculate the hash value 505 for data block 501. The proof-of-stake function may be any function that assigns the duty of completing a particular data block to a particular member system based upon some stake held in the success of blockchain 540. As a nonlimiting example, proof-of-stake may be based upon the number of records inserted by a member system in the blockchain 540, by the length of membership of member system in the blockchain 540, or by any other means. Member systems having larger stakes in the blockchain 540 may have the opportunity to complete data blocks more frequently than member systems having a lesser stake in the blockchain 540. In the case where blockchain 540 is a consortium blockchain containing only member systems, the hash value 505 for each data block 501 may be a simple hash of the block.

In various embodiments, blockchain 540 may comprise a private blockchain, which may be a consortium blockchain in which only member systems may complete blocks, but which may also include user systems which may publish records for inclusion in blocks and which may read the blockchain. The private blockchain may allow only member systems (for instance, member devices associated with or deemed members by the authentication platform) to have copies of the blockchain 540 or may allow both member systems and user systems (for instance, user computing devices, such as computing device 150) to have copies of the blockchain 540, but only allow member systems to complete blocks for inclusion in blockchain 540.

In an exemplary embodiment, blockchain 540 may comprise a public blockchain in which any node may participate in the blockchain 540 and complete blocks in the blockchain 540. In such cases, it may be desirable that data payloads 507, or individual records in data payloads 507, be encrypted before being included in the data payload 507 of a data block 501. In one embodiment, the public blockchain will require that a proof-of-work condition be satisfied to complete each data block 501 in blockchain 540. In such cases, a node completing a block may be given a reward.

Cryptographic keys may be used to encrypt elements of data payloads 507 in data blocks 501, consistent with disclosed embodiments. In some embodiments, such cryptographic keys may be associated with member systems. Corresponding cryptographic keys may be available to decrypt the encrypted data payloads, consistent with disclosed embodiments. For example, when a data payload in a block is encrypted with a symmetric key, the same symmetric key may be available for decrypting the encrypted element. As another example, when a data payload of a message in a block is encrypted with a private key, a corresponding public key may be available for decrypting the encrypted element. In various embodiments, the corresponding cryptographic keys may be available to member systems.

Included herein are one or more logic flows representative of exemplary methodologies for performing novel aspects of the disclosed embodiments. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation. Blocks designated with dotted lines may be optional blocks of a logic flow.

A logic flow may be implemented in software, firmware, hardware, or any combination thereof. In software and firmware embodiments, a logic flow may be implemented by computer executable instructions stored on a non-transitory computer readable medium or machine-readable medium. The embodiments are not limited in this context.

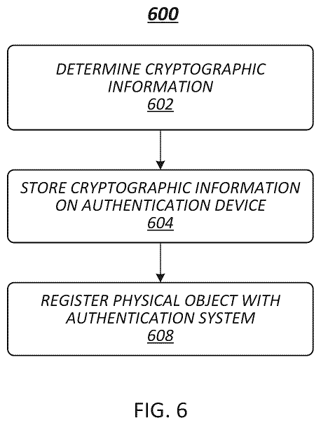

FIG. 6 illustrates an embodiment of a first logic flow according to the present disclosure. Logic flow 600 may be representative of some or all of the operations executed by one or more embodiments described herein, such as computing device 150, authentication management system 106. In some embodiments, logic flow 600 may be representative of some or all of the operations processing of registering a physical object with an authentication platform according to some embodiments.

At block 602, logic flow 600 may determine the cryptographic information. For example, the cryptographic information may include a public key and a private key for an encryption/decryption process according to some embodiments. In another example, the cryptographic information may include various identifiers associated with a physical object, such as an object ID.

Logic flow 600 may store the cryptographic information on an authentication device at block 604. For example, the private key may be stored in an enclave of a cryptographic processor of the authentication device. In another example, the object ID and/or the public may be stored on the authentication device, such as in the enclave or in a standard memory location.

At block 608, logic flow 600 may register the physical object with the authentication system. For example, the authentication device may be communicatively coupled to an authentication management system and an information storage system thereof, such as a blockchain. The authentication device may be directly communicatively coupled to the authentication management system, such as via a wired or wireless network, or through a computing device in communication with the authentication device, such as through NFC, Bluetooth, and/or the like. The authentication device may export the public key, object ID, and any other information (for instance, metadata associated with the physical object) to the authentication management system for immutable storage in an information database, such as a blockchain. The authentication management system may register the authentication device as being associated with the physical object affixed to the authentication device by registering the authentication device and the object information in the blockchain.

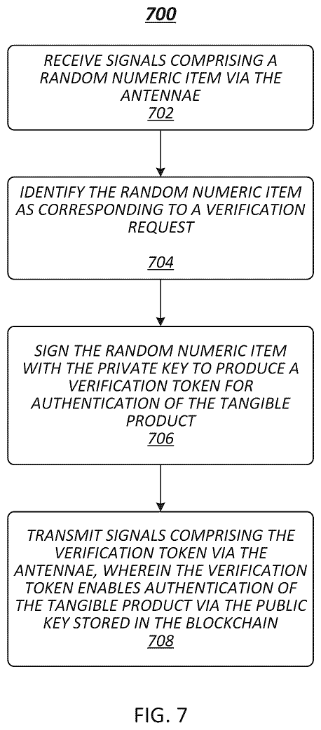

FIG. 7 illustrates an embodiment of a second logic flow according to the present disclosure. Logic flow 700 may be representative of some or all of the operations executed by one or more embodiments described herein, such as computing device 150, authentication management system 106. In some embodiments, logic flow 700 may be representative of some or all of the operations processing of recording a transaction with an authentication platform according to some embodiments.

At block 702, logic flow 700 may receive signals comprising a challenge element, for instance, a random numeric item, via an antenna. For example, communication system 126 and/or 226 may receive a random number element from authentication management system 106, for instance, in response to a request to perform a transaction. Such as verification, transfer, sale, merge, and/or the like. Logic flow 700 may identify the random numeric item as corresponding to a verification request at block 704. For example, the random numeric item may be analyzed by cryptographic processor 130 and determined to be a challenge element, for instance, based on formatting, symbols, codes, a header, and/or the like in the random numeric element.

At block 706, logic flow 700 may sign the random numeric item with the private key to produce a verification token for authentication of the physical object. For example, cryptographic processor 130 may encrypt the random numeric item using private key 244 via encryption processes performed by encryption/decryption application 243. In some embodiments, the encryption process performed by encryption/decryption application 243 may generate a verification token. At block 708, logic flow 700 may transmit signals comprising the verification token via the antennae, wherein the verification token enables authentication of the physical object via the public key stored in the blockchain. For example, authentication device 110 via an antenna of communication system 126 and/or communication system 226 may transmit the verification token to computing device 150 and/or authentication management system 106. Authentication of the verification token may cause authentication of the associated physical object.

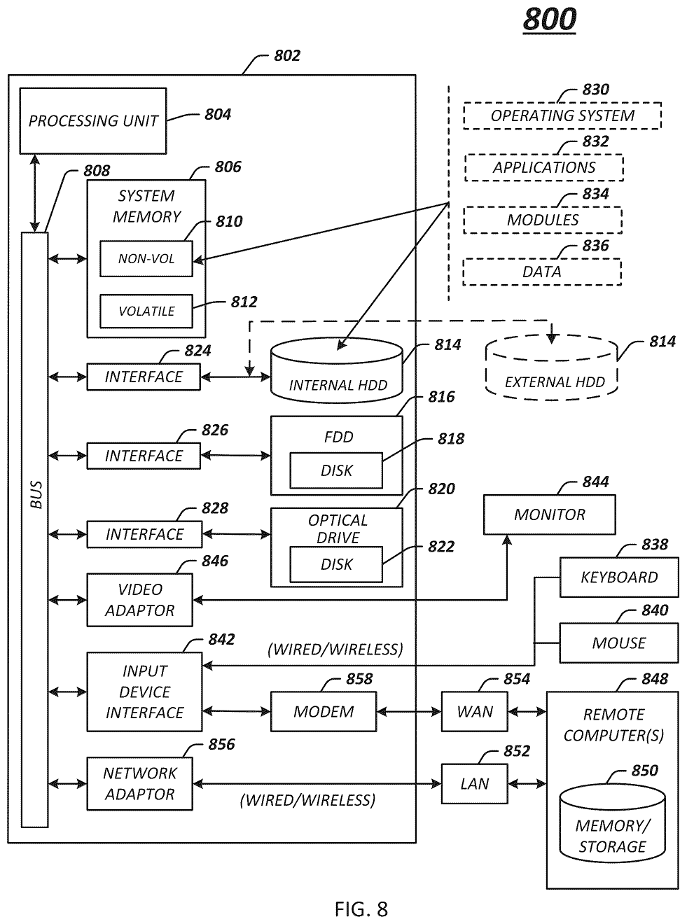

FIG. 8 illustrates an embodiment of an exemplary computer architecture 800 suitable for implementing various embodiments as previously described. In one embodiment, the computer architecture 800 may include or be implemented as part of computing architecture 100.

As used in this application, the terms “system” and “component” are intended to refer to a computer-related entity, either hardware, a combination of hardware and software, software, or software in execution, examples of which are provided by the exemplary computing computer architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computer architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing computer architecture 800.

As shown in FIG. 8, the computer architecture 800 includes a computer 812 comprising a processor 802, a system memory 804 and a system bus 806. The processor 802 can be any of various commercially available processors. The computer 812 may be representative of the computing device 150, the authentication device 110, and/or the authentication management system 106.

The system bus 806 provides an interface for system components including, but not limited to, the system memory 804 to the processor 802. The system bus 806 can be any of several types of bus structure that may further interconnect to a memory bus (with or without a memory controller), a peripheral bus, and a local bus using any of a variety of commercially available bus architectures. Interface adapters may connect to the system bus 806 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computer architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 804 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM

(EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 804 can include non-volatile 808 and/or volatile 810. A basic input/output system (BIOS) can be stored in the non-volatile 808.

The computer 812 may include various types of computer-readable storage media in the form of one or more lower speed memory units, including an internal (or external) hard disk drive 814, a magnetic disk drive 816 to read from or write to a removable magnetic disk 818, and an optical disk drive 820 to read from or write to a removable optical disk 822 (e.g., a CD-ROM or DVD). The hard disk drive 814, magnetic disk drive 816 and optical disk drive 820 can be connected to the system bus 806 by an HDD interface 824, and FDD interface 826 and an optical disk drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 808, and volatile 810, including an operating system 830, one or more applications 832, other program modules 834, and program data 836. In one embodiment, the one or more applications 832, other program modules 834, and program data 836 can include, for example, the various applications and/or components of the system 100.

A user can enter commands and information into the computer 812 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 802 through an input device interface 842 that is coupled to the system bus 806 but can be connected by other interfaces such as a parallel port, IEEE 1394 serial port, a game port, a USB port, an IR interface, and so forth.

A monitor 844 or other type of display device is also connected to the system bus 806 via an interface, such as a video adapter 846. The monitor 844 may be internal or external to the computer 812. In addition to the monitor 844, a computer typically includes other peripheral output devices, such as speakers, printers, and so forth.

The computer 812 may operate in a networked environment using logical connections via wire and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all the elements described relative to the computer 812, although, for purposes of brevity, only a memory and/or storage device 850 is illustrated. The logical connections depicted include wire/wireless connectivity to a local area network 852 and/or larger networks, for example, a wide area network 854. Such LAN and WAN networking environments are commonplace in offices and companies, and facilitate enterprise-wide computer networks, such as intranets, all of which may connect to a global communications network, for example, the Internet.

When used in a local area network 852 networking environment, the computer 812 is connected to the local area network 852 through a wire and/or wireless communication network interface or network adapter 856. The network adapter 856 can facilitate wire and/or wireless communications to the local area network 852, which may also include a wireless access point disposed thereon for communicating with the wireless functionality of the network adapter 856.

When used in a wide area network 854 networking environment, the computer 812 can include a modem 858, or is connected to a communications server on the wide area network 854 or has other means for establishing communications over the wide area network 854, such as by way of the Internet. The modem 858, which can be internal or external and a wire and/or wireless device, connects to the system bus 806 via the input device interface 842. In a networked environment, program modules depicted relative to the computer 812, or portions thereof, can be stored in the remote memory and/or storage device 850. It will be appreciated that the network connections shown are exemplary and other means of establishing a communications link between the computers can be used.

The computer 812 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, ac, ax, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1A-12 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A system, comprising:
a physical object;
an authentication device integrally attached to the physical object, the authentication device comprising:
an antenna;
a processor;
a secure enclave comprising a private key uniquely associated with the physical object via a public key stored in a blockchain; and
memory comprising instructions that when executed by the processor cause the processor to:
receive signals comprising a challenge element via the antenna;
identify the challenge element as corresponding to a verification request;
sign the challenge element with the private key to produce a verification token for authentication of the physical object; and
transmit signals comprising the verification token via the antenna,
wherein the verification token enables authentication of the physical object via the public key stored in the blockchain.

2. The system of claim 1, wherein the challenge element comprises a random numeric item generated based on a randomization function, wherein the instructions, when executed by the processor, further cause the processor to provision the public key, the private key, and a unique identifier associated with the physical object.

3. The system of claim 1, wherein the instructions, when executed by the processor, further cause the processor to register the public key and a unique identifier associated with the physical object in the blockchain.

4. The system of claim 1, wherein the instructions, when executed by the processor, further cause the processor to register an owner of the physical object in the blockchain.

5. The system of claim 1, wherein the instructions, when executed by the processor, further cause the processor to transfer ownership of the physical object from a first owner to a second owner in the blockchain.

6. The system of claim 1, wherein the physical object comprises a first physical object and the instructions, when executed by the processor, further cause the processor to associate the first physical object with a second physical object in the blockchain to register a composite item comprising the first physical object and the second physical object in the blockchain.

7. The system of claim 6, wherein the second physical object is integrally attached to a second authentication device comprising a second antenna, a second processor, and a second secure enclave comprising a second private key uniquely associated with the second physical object via a second public key stored in the blockchain.

8. The system of claim 1, wherein removal of the authentication device from the physical object destroys functionality of at least one of the antenna, the processor, the secure enclave, and the memory.

9. The system of claim 1, wherein a portion of the physical object is interwoven with the antenna to integrally attach the authentication device to the physical object.

10. The system of claim 1, wherein the authentication device comprises a digital cryptographic processor.

11. An apparatus, comprising:
an authentication device integrally attachable to a physical object, the authentication device comprising:
an antenna;
a processor;
a secure enclave comprising a private key uniquely associated with the physical object via a public key stored in a blockchain; and
memory comprising instructions that when executed by the processor cause the processor to:
receive signals comprising a challenge element via the antenna;
identify the challenge element as corresponding to a verification request;
sign the challenge element with the private key to produce a verification token for authentication of the physical object; and
transmit signals comprising the verification token via the antenna
wherein the verification token enables authentication of the physical object via the public key stored in the blockchain.

12. The apparatus of claim 11, wherein the challenge element comprises a random numeric item generated based on a randomization function, wherein the instructions, when executed by the processor, further cause the processor to provision the public key, the private key, and a unique identifier associated with the physical object.

13. The apparatus of claim 11, wherein the instructions, when executed by the processor, further cause the processor to register the public key and a unique identifier associated with the physical object in the blockchain.

14. The apparatus of claim 11, wherein the instructions, when executed by the processor, further cause the processor to register an owner of the physical object in the blockchain.

15. The apparatus of claim 11, wherein the instructions, when executed by the processor, further cause the processor to transfer ownership of the physical object from a first owner to a second owner in the blockchain.

16. The apparatus of claim 11, wherein the physical object comprises a first physical object and the instructions, when executed by the processor, further cause the processor to associate the first physical object with a second physical object in the blockchain to register a composite item comprising the first physical object and second the physical object in the blockchain.

17. The apparatus of claim 16, wherein the second physical object is integrally attached to a second authentication device comprising a second antennae, a second processor, and a second secure enclave comprising a second private key uniquely associated with the second physical object via a second public key stored in the blockchain.

18. The apparatus of claim 11, wherein, when integrally attached to the physical object, removal of the authentication device from the physical object destroys functionality of at least one of the antenna, the processor, the secure enclave, and the memory.

19. A method of authenticating a physical object, the method comprising, via an authentication device integrally attached to the physical object:
receiving signals comprising a challenge element via an antenna of the authentication device;
identifying the challenge element as corresponding to a verification request;
signing the challenge element with a private key stored in a secure enclave of the authentication device to produce a verification token for authentication of the physical object; and
transmitting signals comprising the verification token via the antenna, wherein the verification token enables authentication of the physical object via a public key stored in a blockchain.

20. The method of claim 19, comprising, via the authentication device, registering the public key and a unique identifier associated with the physical object in the blockchain.
